(19) United States
(12) Patent Application Publication
(10) Pub. No.: US 2002/0110166 A1
(43) Pub. Date: Aug. 15, 2002

(54) Method and system for cooling a laser gain medium

(76) Inventor: David M. Filgas, Newbury Park, CA (US)

Correspondence Address: David R. Syrowik, Brooks & Kushman P.C., 22nd Floor, 1000 Town Center, Southfield, MI, 48075-1351, US

(21) Appl. No.: 09/783,457

(22) Filed: Feb. 14, 2001

(51) Int. Cl. H01S 3/04

(52) U.S. Cl. 372/36

(57) ABSTRACT

A method and system provide improved surface cooling of a laser gain medium such as a solid state disc through the presence of a layer of a highly conductive liquid separating the solid state disc from a heat sink of the system. The highly conductive liquid, such as, for example, mercury, is placed to serve as a conductor of heat between the disc and the heat sink. Liquid allows for good thermal contact between the heat sink and the disc reducing the problem of thermal contact resistance found when more solid means of contact are used.

### TECHNICAL FIELD

The present invention relates to methods and systems for cooling a laser gain medium.

### BACKGROUND ART

In general, laser systems aim to achieve high output power while maintaining high beam quality. During operation, inefficiencies in laser systems cause heating of the gain medium. Thermal effects resulting from this heating can adversely affect the beam quality, particularly at high power.

Thermal effects commonly found in lasers having solid state gain media include distortion, fracture and thermal lensing of the gain medium. In solid state lasers, the optically pumped gain medium is typically pumped throughout its volume but cooled only on the surface. The gain medium expands due to an increase in temperature resulting from the portion of the pumping power which is dissipated as heat in the gain medium. This causes the optical surfaces of the gain medium to distort and become stressed. Thermally induced stress exceeding the rupture strength of the gain medium material causes the gain medium to fracture. Thermal lensing results from changes in the index of refraction of the gain medium due to thermal gradients and stresses. In rod-shaped solid state lasers, this thermal lensing causes the gain medium to act as a lens whose focal length is inversely proportional to the amount of heat dissipated in the gain medium. As a result of the thermal lensing the beam quality is degraded.

Some solid state lasers are designed to operate at a single operating power so that constant pumping power and constant temperatures gradients are maintained thereby stabilizing thermally-induced effects to the laser gain medium. However, many current laser applications require that a user controlled variable output power feature be available in order to enhance the functionality of the laser. Disc or thin plate lasers have been proposed in the prior art to at least partially deal with this problem (See for example U.S. Pat. No. 5,553,088 issued Sep. 3, 1996, hereby incorporated by reference).

The advantage of disc or thin plate laser systems is that the gain medium can be pumped at a high pumping power since the heat resulting thereby can be transferred to a solid cooling element via a cooling surface at one or both surfaces of the disc. The temperature gradient formed in the gain medium does not have a negative effect on the beam quality of the laser radiation field at high pumping power since the laser radiation field propagates approximately parallel to the temperature gradient in the gain medium so the temperature gradient is constant across the laser beam cross-section. In summary, the use of a surface-cooled disc or thin plate laser material geometry can in principle result in reduced thermal lens distortion, thus, good beam quality at high output power can be achieved.

However, in practice, solid state laser assemblies (including disc, slab, and rod type laser mediums) continue to be hampered by thermal effects when pumped at broad power ranges (i.e. from low to high power). While solid heat sinks can provide more efficient heat removal than flowing water, this efficiency is dependent on good thermal contact between the heat sink and the gain medium. Most gain media being cooled by solid heat sinks are solidly bonded to the heat sink, for example, by the use of solder or thermally conductive adhesive. This creates an inflexible bond between the heat sink and the gain medium. If the heat sink and gain medium have different coefficients of thermal expansion then this solid bond will cause stress in the gain medium during expansion. In some cases, the stresses can even break the bond to the heat sink, reducing the efficiency of the heat sink as thermal contact with the gain medium is reduced.

U.S. Pat. No. 5,848,081 discloses an insulating barrier between the laser medium and the bulk of the cooling fluid flow in order to operate the gain medium at an elevated temperature. The small gap between the insulator and the gain medium is filled with the cooling fluid. This guarantees good thermal contact between the insulator and the gain medium. The purpose of the insulator is to operate the gain medium at a temperature significantly higher than that of the cooling fluid used to cool the insulator.

U.S. Pat. No. 5,696,783 discloses a cooling system wherein the bulk of the heat is removed by cooling fluid via forced convection. In this patent, the heat is carried away by the cooling fluid.

### SUMMARY OF THE INVENTION

It is an object of the present invention to provide an improved method and system for cooling a laser gain medium.

In carrying out the above object and other objects of the present invention, a method for cooling a laser gain medium having a thermal conductivity is provided. The method includes positioning a heat sink made of a material with a thermal conductivity greater than the thermal conductivity of the gain medium adjacent the gain medium. The method further includes fluidly conducting heat from the gain medium to the heat sink to cool the gain medium.

The step of fluidly conducting may include the step of providing a fluid layer having a relatively low thermal resistance in thermal contact with both the gain medium and the heat sink so that most of the heat removed from the gain medium is removed by conduction through the fluid layer and into the heat sink.

The fluid layer may be static or nearly static.

The heat sink may be a solid heat sink.

The gain medium may be a solid state gain medium such as a thin disk laser crystal.

The fluid layer may also be a layer of water, or may be a metal liquid at or near room temperature such as mercury, gallium or a gallium alloy.

The method may further include cooling the heat sink by forced convection such as with a cooling fluid.

The step of cooling the heat sink by forced convection may further include the step of cooling the heat sink by forced convection with a fluid that is the same as the fluid of the fluid layer, or with a fluid that is different than the fluid of the fluid layer.

In further carrying out the above object and other objects of the present invention, a system for cooling a laser gain medium having a thermal conductivity is provided. The system includes a heat sink made of a material with a thermal conductivity greater than the thermal conductivity of the gain medium positioned adjacent the gain medium. The system also includes a fluid conductor for conducting heat from the gain medium to the heat sink to cool the gain medium.

The fluid conductor may be a fluid layer having a relatively low thermal resistance in thermal contact with both the gain medium and the heat sink so that most of the heat removed from the gain medium is removed by conduction through the fluid layer and into the heat sink.

The fluid layer may be static or nearly static.

The heat sink may be a solid heat sink.

The gain medium may be a solid state gain medium such as a thin disk laser crystal.

The fluid layer may further be a layer of water, or may be a metal liquid at or near room temperature, such as mercury, gallium or a gallium alloy.

The system may further include a cooling subsystem for cooling the heat sink by forced convection such as with a cooling fluid.

The cooling subsystem may include a source of fluid that is the same as the fluid of the fluid layer, or that is different than the fluid of the fluid layer.

Thermal resistance combines the thermal conductivity of the liquid and the thickness of the liquid layer into a single parameter. A very thin layer of a poor thermal conductivity liquid could have a thermal resistance as low as a thicker layer of a higher thermal conductivity liquid. Thermal conductivity(k) is measured in W/cm° C. For linear heat transfer by conduction, thermal resistance is defined as Rth=Dx/(kA) where Dx is the thickness of the conducting layer, k is the thermal conductivity of the conducting layer, and A is the cross-sectional area of the heat flow. The units of thermal resistance are ° C/W. Alternatively, the fluid layer is a relatively thin fluid layer having a good thermal conductivity.

The above objects and other objects, features, and advantages of the present invention are readily apparent from the following detailed description of the best mode for carrying out the invention when taken in connection with the accompanying drawings.

### BRIEF DESCRIPTION OF THE DRAWINGS

Embodiments of the present invention will be described by way of example in conjunction with the drawings in which:

FIG. 1 is a schematic view of a disc laser cooling assembly for a disc type laser according to an embodiment of the present invention;

FIG. 2 is a sectional view of the disc laser cooling assembly of the present invention;

FIG. 3 is a sectional view of a cooling assembly for an end pumped rod laser according to an embodiment of the present invention; and

FIG. 4 is a sectional view of a disc laser cooling assembly illustrating flowing liquid according to an embodiment of the present invention.

### DETAILED DESCRIPTION OF THE PREFERRED EMBODIMENT(S)

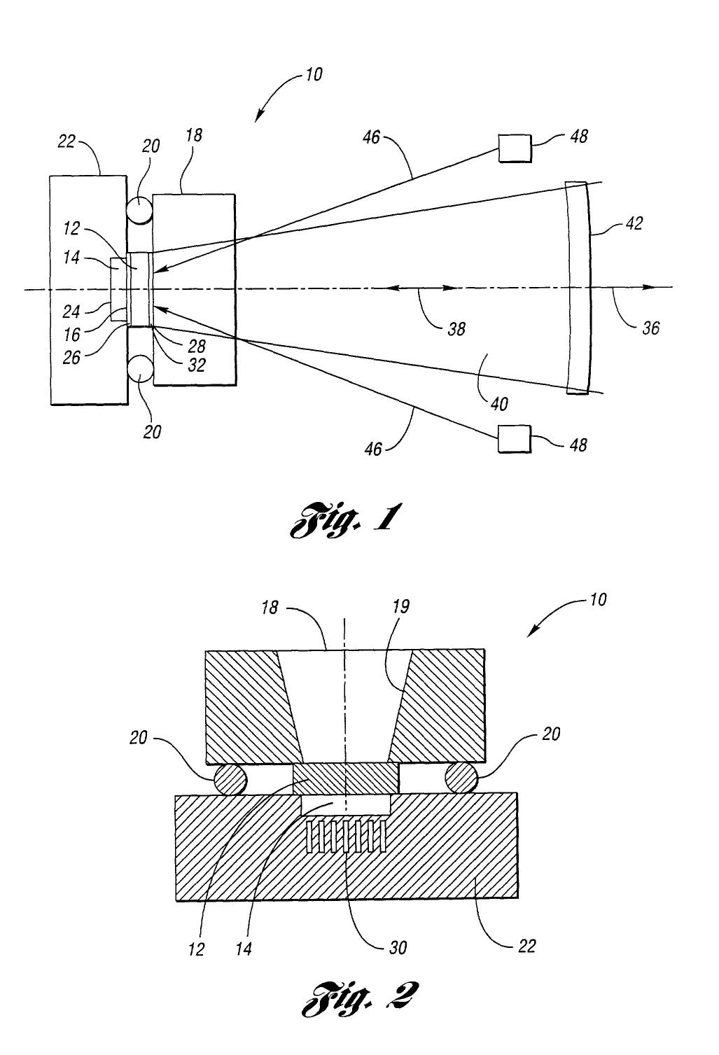

FIG. 1 illustrates a disc laser cooling assembly generally indicated at 10 according to an embodiment of the present invention to provide improved surface cooling of a solid state laser disc 12 having a gain medium such as Nd:YAG or Yb:YAG. Disposed on both sides of the disc 12 to capture the disc 12 therebetween are a heat sink body 22 made of suitable thermally conductive material(s) and a holding body 18 made from a suitable optically transparent material, such as glass, fused silica, or sapphire. The disc 12 is attached to the holding body 18 preferably via a diffusion bond to prevent curvature distortion of the disc 12. Alternatively, the holding body 18 may have an aperture 19 as shown in FIG. 2 disposed over the disc 12 such that the holding body 18 does not cover the entire surface of the disc 12.

Thermally conductive materials include metals such as copper, brass, aluminum, nickel, and alloys thereof; other materials such as diamond and silicon carbide; and gold or nickel-coated versions of these materials.

A heat sink side 16 of the disc 12 includes a reflector layer 26. The reflector layer 26 is preferably highly reflecting at both the laser and pump wavelengths. An output side 28 of the disc 12 includes an optional anti-reflective coating 32. If the refractive index of the disc 12 is close to that of the holding body 18 (i.e. difference of less than 0.2) then reflection at the interface is negligible and the anti-reflective coating 32 may not be necessary.

A laser radiation field 40 is formed between an output coupling mirror 42, which generates a laser output beam 36, and the disc 12. The laser radiation field 40 enters the disc 12 and is reflected by the reflector layer 26. The disc 12 is also penetrated by pumping light 46 from pumping light radiation source(s) 48. The pumping light 46 leads to an excitation of the disc 12, in particular in the region thereof penetrated by the laser radiation field 40.

The thermal conductivity of the heat sink 22 is greater than that of the disc 12 so that more efficient heat conduction takes place in the heat sink 22 than in the disc 12. A temperature gradient results in the disc 12 that is parallel to a direction of propagation 38 of the laser radiation field 40. Face cooling of the disc 12 minimizes temperature gradients perpendicular to the direction of propagation 38 of the laser beam that could create thermal lensing.

When pumped throughout its volume but cooled only on one face, the disc 12 will distort due to the thermal gradients within the disc 12. The distortion can consist of both curvature and bulging of the disc 12. If the disc 12 relied on physical contact or a rigid bond with the heat sink for cooling, this distortion could reduce the thermal contact between the disc 12 and the heat sink 22, thereby reducing the cooling effectiveness of the heat sink 22 thereby degrading the laser beam quality and risking fracture of the disc 12.

Separating the disc 12 from the heat sink 22 is a cavity 14 in which a high thermal conductivity liquid (e.g., mercury or a mercury substitute such as liquid gallium or a gallium alloy as disclosed in U.S. Pat. No. 5,792,236) is placed to serve as a heat conductor between the disc 12 and the heat sink 22. The presence of the liquid allows for good thermal contact between the heat sink 22 and the disc 12 reducing the problem of increased thermal contact resistance during disc 12 distortion found when more solid means of contact, such as solder or physical pressure, are used. The fluidity of the high thermal conductivity liquid allows for efficient cooling of the disc 12 even if the shape of the disc distorts under thermal loading. The fluidity of the high thermal conductivity liquid in the cavity 14 also avoids putting additional stress into the disc 12 as the liquid conforms to the shape of the disc 12 as the disc 12 thermally expands and contracts.

The relative sizes of the various layers shown in FIG. 1 are exemplary. The heat sink 22 surface area could be the same as that of the disc 12 and the holding body 18.

For improved cooling of the disc 12, it is beneficial to minimize the temperature difference between a surface 16 of the disc 12 and a surface 24 of the heat sink 22. This temperature difference between the surface 16 of the disc 12 and the surface 24 of the heat sink 22 can be represented by the following equation: ΔT=Q (Δx /k A ) where ΔT is the temperature difference (° C.) between surface 16 and surface 24, Q is the heat dissipated (W) from surface 16 to surface 24, Δx is the thickness of the liquid layer (cm), k is the thermal conductivity of the liquid (W/cm° C.) and A is the cross sectional area of the heat flow (cm²).

If a minimum temperature difference (ΔT) is desired then the liquid layer thickness (Δx) must be small and the liquid must have a high thermal conductivity (k). The value of Q is proportional to the laser output power and A will remain relatively constant changing only for implementation purposes (i.e., with the size of the disc 12). If an exemplary surface area (A) of 0.8 cm², thickness (Δx) of 0.01 cm for a heat dissipation (Q) of 200 W is used with Mercury (k=0.081 W/cm° C.) as the liquid then the approximate temperature differential (ΔT) will be 30.8° C. When water (k=0.00609 W/cm° C.) is used as the liquid in the same situation the temperature differential (ΔT) becomes approximately 410° C.

FIG. 2 shows the laser cooling assembly 10 of FIG. 1 with the heat sink 22 being water cooled. Channels 30 are formed in the heat sink 22 for passing water therethrough to cool the heat sink 22. A seal 20 is situated between the heat sink 22 and the holding body 18 to prevent the high thermal conductivity liquid from leaking through the space between these two bodies.

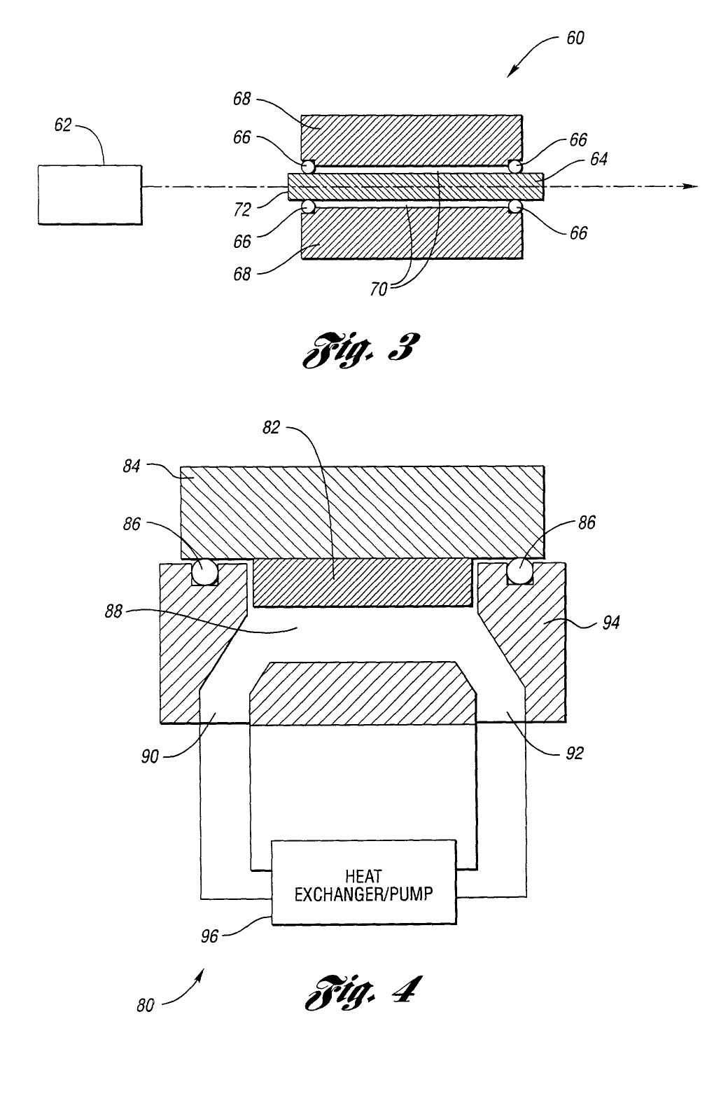

FIG. 3 shows a cooling assembly generally indicated at 60 for an end pumped cylindrical rod laser according to an embodiment of the present invention. As a gain medium 64 is optically pumped through an end 72 and not through a side surface in this embodiment, a heat sink 68 surrounds the gain medium 64 with a thin annular gap 70 between the inner surface of the heat sink 68 and the gain medium 64. The gain medium 64 is in thermal contact with the heat sinks 68 via high thermal conductivity liquid contained within the gap 70. This liquid is sealed into the cooling assembly 60 via seals 66, such as, for example, O-ring seals.

FIG. 4 shows a cooling assembly generally indicated at 80 according to an embodiment of the present invention for use in a disc type laser system such as the system 10 in FIG. 1. A solid state laser disc 82 is bonded to a holding body 84 made from a suitable optically transparent material, such as, for example, glass, fused silica or sapphire. A fluid holding body 94 is disposed on a side of the disc 82 opposite the holding body 84 to contain high thermal conductivity liquid (e.g., mercury) used for cooling the disc 82. Liquid enters the fluid holding body 94 through an inlet 90 and flows by the disc 82 in a passage 88. As the liquid flows by the disc 82 heat is removed from the disc 82.

It is preferable that the high thermal conductivity liquid be at least twice as conductive as water to efficiently remove heat from the disc 82. The liquid leaves the fluid holding body 94 via an outlet 92. The outlet 92 is connected to a heat exchanger and pump 96 that moves the liquid through the cooling assembly 80 and removes heat from the liquid before it returns to the fluid holding body 94. Seals 86 are placed around the fluid holding body 94 for keeping the high thermal conductivity liquid within the body 94.

While the best mode for carrying out the invention has been described in detail, those familiar with the art to which this invention relates will recognize various alternative designs and embodiments for practicing the invention as defined by the following claims.

What is claimed is:

1. A method for cooling a laser gain medium having a thermal conductivity, the method comprising:
positioning a heat sink made of a material with a thermal conductivity greater than the thermal conductivity of the gain medium adjacent the gain medium; and
fluidly conducting heat from the gain medium to the heat sink to cool the gain medium.

2. The method as claimed in claim 1 wherein the step of fluidly conducting includes the step of providing a fluid layer having a relatively low thermal resistance in thermal contact with both the gain medium and the heat sink so that most of the heat removed from the gain medium is removed by conduction through the fluid layer and into the heat sink.

3. The method as claimed in claim 2 wherein the fluid layer is static or nearly static.

4. The method as claimed in claim 1 wherein the heat sink is a solid heat sink.

5. The method as claimed in claim 1 wherein the gain medium is a solid state gain medium.

6. The method as claimed in claim 1 wherein the gain medium is a thin disk laser crystal.

7. The method as claimed in claim 2 wherein the fluid layer is a layer of water.

8. The method as claimed in claim 2 wherein the fluid layer is a metal liquid at room temperature.

9. The method as claimed in claim 8 wherein the fluid layer is a layer of mercury.

10. The method as claimed in claim 8 wherein the fluid layer is a layer of liquid gallium or gallium alloy.

11. The method as claimed in claim 2 further comprising cooling the heat sink by forced convection.

12. The method as claimed in claim 11 wherein the step of cooling is performed with a cooling fluid.

13. The method as claimed in claim 11 wherein the step of cooling the heat sink by forced convection includes the step of cooling the heat sink by forced convection with a fluid that is different than the fluid of the fluid layer.

14. A system for cooling a laser gain medium having a thermal conductivity, the system comprising:
a heat sink made of a material with a thermal conductivity greater than the thermal conductivity of the gain medium positioned adjacent the gain medium; and
a fluid conductor for conducting heat from the gain medium to the heat sink to cool the gain medium.

15. The system as claimed in claim 14 wherein the fluid conductor is a fluid layer having a relatively low thermal resistance in thermal contact with both the gain medium and the heat sink so that most of the heat removed from the gain medium is removed by conduction through the fluid layer and into the heat sink.

16. The system as claimed in claim 15 wherein the fluid layer is static or nearly static.

17. The system as claimed in claim 14 wherein the heat sink is a solid heat sink.

18. The system as claimed in claim 14 wherein the gain medium is a solid state gain medium.

19. The system as claimed in claim 14 wherein the gain medium is a thin disk laser crystal.

20. The system as claimed in claim 15 wherein the fluid layer is a layer of water.

21. The system as claimed in claim 15 wherein the fluid layer is a metal liquid at room temperature.

22. The system as claimed in claim 21 wherein the fluid layer is a layer of mercury.

23. The system as claimed in claim 21 wherein the fluid layer is a layer of liquid gallium or gallium alloy.

24. The system as claimed in claim 15 further comprising a cooling subsystem for cooling the heat sink by forced convection.

25. The system as claimed in claim 24 wherein the cooling subsystem includes a source of fluid that is the same as the fluid of the fluid layer.

26. The system as claimed in claim 24 wherein the cooling subsystem includes a source of fluid that is different than the fluid of the fluid layer.

27. A method for cooling a solid state laser gain medium, the method comprising:
cooling the gain medium by forced convection with a cooling fluid having a thermal conductivity which is at least twice the thermal conductivity of water.

28. The method as claimed in claim 27 wherein the cooling fluid is a liquid metal.
